(19) United States
(12) Patent Application Publication
(10) Pub. No.: US 2006/0067472 A1
(43) Pub. Date: Mar. 30, 2006

(54) Method and apparatus for measuring X-ray energy

(76) Inventors: George Edward Possin, Schenectady, NY (US); Steven Jude Duclos, Clifton Park, NY (US)

Correspondence Address: Patrick S. Yoder;FLETCHER YODER, P.O. Box 692289, Houston, TX, 77269-2289, US

(21) Appl. No.: 10/954,732

(22) Filed: Sep. 30, 2004

(51) Int. Cl. H05G 1/64

(52) U.S. Cl. 378/98.9

(57) ABSTRACT

An energy sensitive detector is provided. The detector comprises an array of detector elements, wherein the detector elements comprises a first scintillator configured to emit photons within a first wavelength range when stimulated by X-rays, a second scintillator configured to emit photons within a second wavelength range when stimulated by X-rays, and a photo-detecting component configured to generate a first signal and a second signal, wherein the first signal and second signals are substantially linear functions of the number of photons emitted within the first and second wavelength ranges.

### BACKGROUND

The invention relates generally to the field of imaging systems. In particular, the invention relates to the detection of X-ray energy.

In a medical context it is often desirable to examine or evaluate the internal structure or condition of a patient without resorting to invasive procedures such as surgery. Similarly, in many industrial or commercial contexts, it is desirable to examine the interior of an object, such as a manufactured part or a closed container, without breaking or opening the item. For such applications, a variety of imaging techniques may be employed to non-invasively create images of the interior of a patient or item so that the desired information may be obtained.

For example, X-ray based imaging techniques are often employed in medical, commercial, industrial, and security contexts to acquire images of regions that are otherwise not visible. In general, these X-ray based techniques measure the incidence of X-rays on a detector to generate an image or profile based on the attenuation of X-rays by the intervening structures, both internal and external. In this manner, images can be generated in which structures that differ in their X-ray attenuating characteristics, such as soft tissue and bone, can be discerned. For example, in the medical context, imaging techniques such as X-ray radiography, fluoroscopy, computer tomography (CT), and tomosynthesis generate different types of two-dimensional and three-dimensional images based on the differential transmission of X-rays through a patient's body.

For many of these X-ray imaging techniques, additional information about the composition of the patient or other imaged object may be obtained by acquiring energy, i.e., spectral, information for the X-rays passing through the imaged object. Because internal structures attenuate different parts of an X-ray spectrum to different degrees, energy information for the X-ray passing through an imaged object may be used to derive compositional information about the object. For example, the X-ray spectra of X-rays attenuated by the body of a patient may contain information about the composition of the structures, i.e., bone, soft tissue, fluid, and so forth, which attenuated the X-rays. This information may be used to create specialized composition images, such as bone or soft tissue images in the medical context, which may be of use to a technologist tasked with evaluating the image data.

Though there may be information benefits to acquiring such X-ray spectra information, there are difficulties associated with such techniques. One such difficulty may be in the construction of a suitable energy sensitive detector. For example, an energy sensitive detector may be built by coupling a scintillator, which generates optical photons in response to X-rays, to a photomultiplier tube (PMT). The PMT detects pulses of photons generated in the scintillator and the intensity of the pulse is proportional to the energy of the X-ray that generated the pulse. However, this detection scheme is most suitable for low X-ray fluxes where individual X-rays can be detected. Furthermore, the PMTs are relatively large. These factors, among others, make this energy sensitive detection technique unsuitable for many imaging modalities, such as CT or other high-resolution systems.

Another type of energy sensitive detector may be constructed by coupling a detector (typically a scintillator and associated photodiode structure) attuned to one energy spectrum of interest to a detector attuned to a different energy spectrum of interest. Such a technique, however, is expensive due to the duplication of parts. In addition, the precise alignment of the two detectors can be difficult. Further, the photodiode of the front detector can absorb X-rays intended for the back detector, generally high energy X-rays, which can cause radiation damage and spurious noise in that element.

Other types of energy sensitive detector have been developed that utilize materials such as cadmium telluride and zinc doped cadmium telluride, which directly convert X-rays into electrical signals. In such direct conversion detectors, however, the quality of the detector signal in these materials is heavily dependent on defect concentrations in the single crystal materials. Currently available materials provide inadequate count rates and stability to make a suitable detector for an imaging system such as a medical CT system. Furthermore, such direct conversion detectors may be too expensive for common use.

Therefore, there is a need for a suitable energy sensitive X-ray detector that addresses some or all of the problems set forth above.

### BRIEF DESCRIPTION

Briefly, according to a first aspect of the invention, an energy sensitive detector for use in an imaging system is provided. The detector includes an array of detector elements and each detector element includes a first scintillator configured to emit photons within a first wavelength range when stimulated by X-rays; a second scintillator configured to emit photons within a second wavelength range when stimulated by X-rays; and a photo-detecting component configured to generate a first signal and a second signal. The first signal and second signals are substantially linear functions of the number of photons emitted within the first and second wavelength ranges.

In a second aspect, an imaging system is provided. The imaging system includes an X-ray source configured to emit X-rays. It also includes an energy sensitive detector. The detector includes an array of detector elements in which each detector element includes a first scintillator configured to emit photons within a first wavelength range when stimulated by X-rays; a second scintillator configured to emit photons within a second wavelength range when stimulated by X-rays; and a photo-detecting component configured to generate a first signal and a second signal. The first signal and second signals are substantially linear functions of the number of photons emitted within the first and second wavelength ranges. The imaging system also includes a detector acquisition circuitry configured to acquire the first signal and the second signal from the energy sensitive detector. The imaging system further includes a system control circuitry configured to control at least one of the X-ray source and the detector acquisition circuitry; and an image processing circuitry configured to process the first signal and the second signal to generate an image.

In a third aspect, a method of forming an energy sensitive detector is provided. The method includes forming a first scintillator layer configured to emit photons within a first wavelength range when stimulated by X-rays; forming a second scintillator layer configured to emit photons within a second wavelength range when stimulated by X-rays; and forming an array of photo detecting elements configured to generate a first signal and a second signal. The first signal and second signals are substantially linear functions of the number of photons emitted within the first and second wavelength ranges.

In a fourth aspect, a method for acquiring X-ray energy data is provided. The method includes emitting X-rays onto an energy sensitive detector comprising a first scintillator and a second scintillator such that the first scintillator emits photons within a first wavelength range and the second scintillator emits photons within the second wavelength range. The incidence of the emitted photons is detected on one or more photo-sensitive elements, where each element is configured to produce a first signal proportional to photons emitted within the first wavelength range and a second signal proportional to photons emitted within the second wavelength range. A relative amount of X-rays at two or more energy levels incident on each element is then determined based on the first signal and the second signal.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatic representation of an exemplary X-ray imaging system implemented according to one aspect of the present technique;

FIG. 2 is a cut-away view of part of an X-ray detector, in accordance with one embodiment of the present invention;

FIG. 3 is a cut-away view of a part of a wavelength discriminating photodiode, in accordance with one embodiment of the present invention;

FIG. 4 is a cut-away view of part of an X-ray detector, in accordance with a different embodiment of the present invention;

FIG. 5 is a cut-away view of part of an X-ray detector, in accordance with an additional embodiment of the present invention;

FIG. 6 is a cut-away view of part of an X-ray detector, in accordance with a further embodiment of the present invention; and

FIG. 7 is a flow chart representing a method for acquiring X-ray energy data according to one aspect of the present technique.

### DETAILED DESCRIPTION

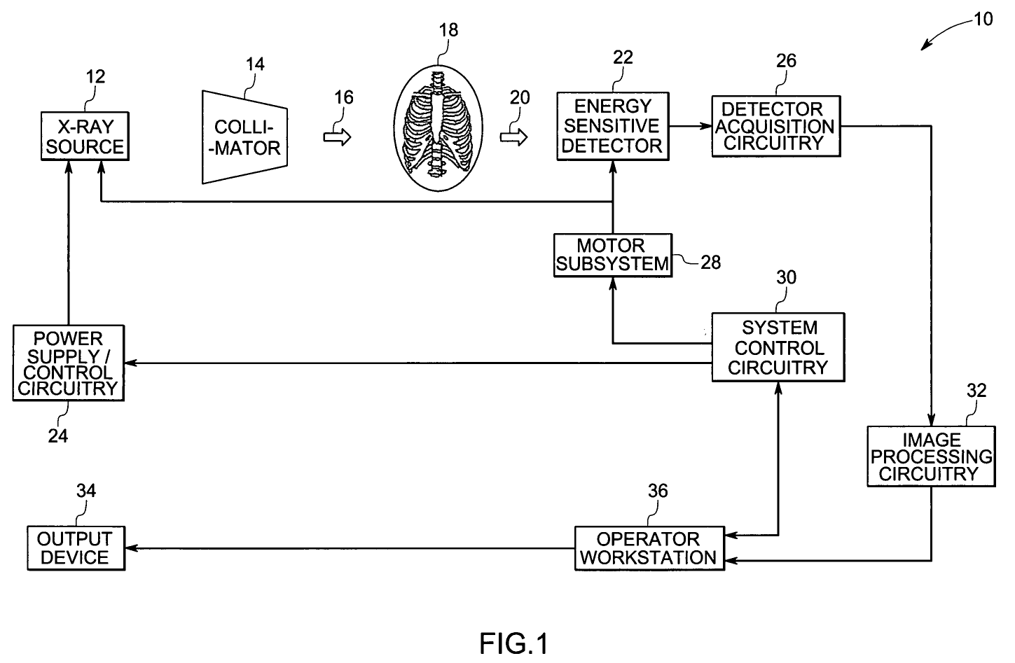

FIG. 1 is an illustration of an X-ray imaging system designated generally by a reference numeral 10. In the illustrated embodiment, the X-ray imaging system 10 is designed to acquire and process image data in accordance with the present technique, as will be described in greater detail below. In FIG. 1, the X-ray imaging system 10 includes an X-ray source 12 configured to emit X-ray radiation. The X-ray radiation emitted by the X-ray source 12 may be filtered, restricted or limited, such as by the action of an adjacent collimator 14, so that the emitted X-rays 16 pass through all or part of an imaging volume in which a target 18, such as a human patient, is positioned. The portion of the radiation passing through the target 18 is typically attenuated and the attenuated radiation 20 impacts an energy sensitive detector 22. As described more fully below, the energy sensitive detector 22 generates electrical signals in response to the X-ray's incident on its surface. These electrical signals, may be processed to derive information about the energy profile of the incident X-rays and to construct an image of the features within the target 18 which reflect this energy information.

The X-ray source 12 is controlled by a power supply/control circuit 24 which furnishes both power and control signals for examination sequences. Moreover, the energy sensitive detector 22 is coupled to a detector acquisition circuitry 26, which commands acquisition of the signals generated by the energy sensitive detector 22. Detector acquisition controller 26 may also execute various signal processing and filtration functions, such as, for initial adjustment of dynamic ranges, interleaving of digital, and so forth.

In some embodiments of the present invention the X-ray source 12 and/or the energy sensitive detector 22 may be mounted to move relative to one another. For example, either or both of the X-ray source 12 and the energy sensitive detector 22 may be mounted on a rotatable gantry, a C-arm, or on some other positioning apparatus. In such embodiments, a motor subsystem 28 is typically present to facilitate motion of the X-ray source 12 and/or the energy sensitive detector 22 by moving the gantry, C-arm, or other positioning apparatus. In other embodiments, motion of the X-ray source 12 and/or the energy sensitive detector 22 may be accomplished manually, such as by the action of an operator. In further embodiments, the X-ray source 12 and the energy sensitive detector 22 may be stationary. In an embodiment the target 18 may be rotated or otherwise moved relative to the source 12 and/or energy sensitive detector 22.

Power supply/control circuit 24 and motor subsystem 28 (if present) are responsive to signals from system control circuitry 30. The system control circuitry 30 also commands operation of the detector acquisition circuitry 26 responsible for acquiring signals generated by the detector 22. In one embodiment, system control circuitry 30 is a component of a general purpose or application specific digital computer, which includes memory circuitry for storing programs and routines executed by the computer, as well as configuration parameters and image data, interface circuits, and so forth. In this embodiment, the general purpose or application specific digital computer may be the operator workstation 36, discussed in greater detail below, or may be a separate computer in communication with the operator workstation 36.

The operator workstation 36 is configured to allow an operator, via one or more input devices (keyboard, mouse, touchpad, etc.) to control the operation of the system control circuitry 30, and, thereby, other components of the imaging system 10. The operator workstation is also configured to render images, such as on an output device 34, such as a display and/or printer, generated during the operation of the imaging system 10. In general, displays, printers, operator workstations, and similar devices supplied within the system may be local to the data acquisition components, may be remote from these components, such as elsewhere within an institution or hospital, or may be in an entirely different location, linked to the image acquisition system via one or more configurable networks, such as the internet, virtual private networks, and so forth.

The images displayed by the operator workstation 36 are typically generated by the image processing circuitry 32, which typically is a component of a general purpose or application specific digital computer, such as the operator workstation 36 or a reconstruction workstation in communication with the operator workstation 36. The image processing circuitry 32 acquires the projection images and/or other image data for processing from the system control circuitry 30 and/or from the detector acquisition circuitry 26. In one embodiment, the image processing circuitry 32 and system control circuitry 30 are both components of the operator workstation 36.

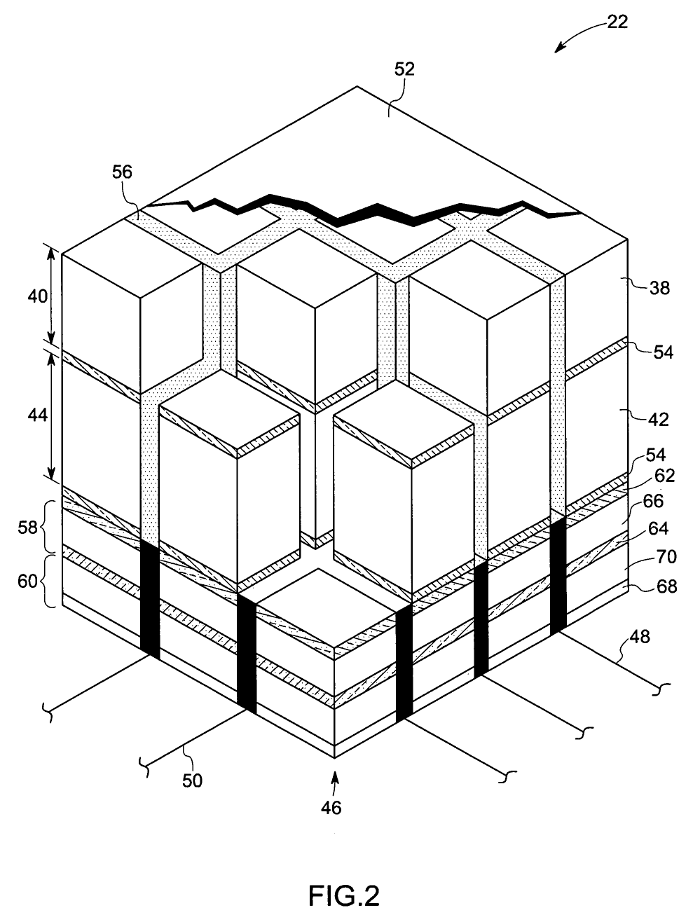

FIG. 2 is a cut-away view of part of an energy sensitive detector 22 employing an array of detector elements, in accordance with one aspect of the present technique. Each detector element generally corresponds to a pixel, or picture element, of the image to be generated. The energy sensitive detector 22 of this embodiment is generally composed of two scintillator layers, a first scintillator 38 having a respective first thickness 40 and a second scintillator 42 having a respective second thickness 44. The first and second scintillators 38 and 42 are generally disposed above a layer of photo-detectors, typically photodiodes and associated readout circuitry configured to read out signals generated in response to the optical photons emitted by the first and second scintillators 38 and 42. As a consequence of this arrangement, each of the detector elements, i.e., pixels, includes two different scintillator layers and a photo-detecting component, such as the aforementioned photodiode.

In addition, other layers may be present, such as a surface reflector 52 on the upper surface of the first scintillator 38 and/or an optically transparent coupling layer 54 disposed between the first and second scintillator 32 and 48 and/or between the second scintillator 48 and the photo-detecting components. A inter scintillator reflector 56 is also typically included to reduce or minimize the optical interaction between pixels (often characterized as light cross talk) and thereby optically isolate the pixels of the detector 22 from one other.

The first and second scintillators 38 and 42 are composed of materials that interact with X-ray photons and emit optical light photons that may be detected by the respective photo-detecting component. In particular, in the depicted embodiment, the first scintillator 38 is composed of a material which, when impacted by an X-ray photon, emits a corresponding optical light photon within a first wavelength range (λ1 to λ1′). Similarly, the second scintillator 42 is composed of a different material which, when impacted by an X-ray photon, emits a corresponding optical light photon within a second wavelength range (λ2 to λ2′). To facilitate distinguishing photons emitted by the first scintillator 38 and the second scintillator 42, it is generally desirable for the first and the second wavelength range to be at least 10 nanometers apart. In one embodiment, the first scintillator and/or the second scintillator are composed of at least one of (Y,Gd)₂O₃:Eu, Gd₃Ga₅O₁₂:Cr, (Lu,Tb)₃Al₅O₁₂:Ce, CdWO₄, Gd₂O₂S:Pr, or any other suitable scintillator composition.

As will be appreciated by those of ordinary skill in the art, in one embodiment the first scintillator 38 will generally respond more strongly to X-rays having a lower energy and the second scintillator will produce a stronger signal from the higher energy X-rays. In other embodiments, however, this relationship may be reversed over a limited range of X-ray energies by the use of K or L-edges using appropriate mixtures of scintillator components with different atomic numbers. In the depicted embodiment, the optical photons emitted by the first and second scintillators 38 and 42, based on their distinctive wavelength ranges are differentially detected by the corresponding photo-detecting component of the pixel. Based on this differential detection, the photo-detecting component generates two signals, S1 and S2 that may be acquired and read out by the readout circuitry. The optical photon fluxes F1 and F2 generated by the first and second scintillators 38 and 42 is a linear function of the two signals from the readout circuitry. Typically F1 and F2 will be a linear function of S1 and S2 and in some embodiments F1 will be proportional to only S1 and F2 will be proportional only to S2. In particular, the signals are linearly related to the photon intensities, F1 and F2, within the two wavelength ranges (λ1 to λ1′) and (λ2 to λ2′) respectively.

In the depicted exemplary embodiment, the photo-detecting component is a wavelength discriminating photodiode 46 comprising a double-layered photodiode structure having a first photodiode 58 disposed on a second photodiode 60. In this embodiment, the wavelength discriminating photodiode 46 operates based on the principle that the greater the wavelength of light incident upon a photo-detecting material substrate, such as silicon, the deeper the light will penetrate into the substrate before it is absorbed. This fact may be used to design a wavelength discriminating photodiode 46 that differentially detects the optical photons generated by the first scintillator 38 and second scintillator 42.

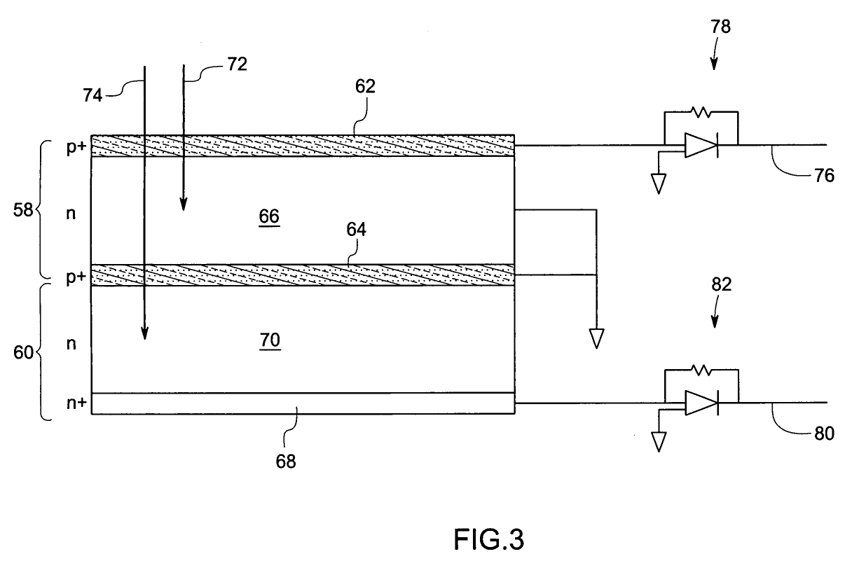

For example, in certain embodiments of the present technique, the wavelength discriminating photodiode 46 includes a photodiode having two lightly doped n-type layers 66 and 70 (as depicted in FIG. 3) of desired thicknesses and two heavily doped p+ contact layers, 62 and 64 of desired thickness disposed on either side of the top lightly doped layer, 62. An n+ contact layer, 68 is provided at the bottom of the second lightly doped n-type layer, 70. Typically layer 70 will be thick and will also function as the mechanical support for the other layers which are thin. In one embodiment, the lightly doped layers are comprised of silicon and have a thickness of between about 1 micron to about 100 microns. For example, if it is desired that the top layer be sensitive to blue light in the range of 400 to 500 nm, layer 66 should be approximately 1 micron thick. If it is desired that the bottom layer 70 be sensitive to red light in the range of 650 to 760 nm then layer 70 should be >10 microns thick. In general, the two heavily doped layers have a relatively low thicknesses compared to the lightly doped layers. A depletion region is formed at the junction of lightly doped and heavily doped layers. This depletion region may or may not extend across the entire thickness of the lightly doped layer. In other words, the lightly doped layers may comprise a depleted region or a combination of depleted and un-depleted regions. In operation, optical photons absorbed within lightly doped layers will produce electron-hole pairs that result in a photo current signal. It should be noted that, both, the depleted and the un-depleted regions of the lightly doped region produce signal. The placement and thickness of the lightly doped layer may be based on known or observed physical principles. For example, the 1/e absorption depth varies from 1 to 10 microns for wavelengths between 500 and 800 nm. As will be appreciated by those of ordinary skill in the art, depletion depths vary from <1 micron to 10's of microns depending on the silicon doping levels and reverse bias (if any). In this example the dopant types can all be reversed and similar operation achieved.

The first photodiode 58, which is stacked above the second photodiode 60 in the depicted embodiment, has a structure similar to that of the second photodiode 60. Optical photons absorbed within layer 66 produce a photocurrent which may be read out and which is a linear combination of the photon fluxes generated by the two scintillators 38 and 42 which differs from that photocurrent generated at layer 70. In one embodiment, the n-doped region 66 is positioned to encompass the approximate absorption depth of optical photons generated by the first scintillator 38, i.e., to absorb photons within the first wavelength (λ1 to λ1′) and the n-doped region 70 is positioned to encompass the approximate absorption depth of optical photons generated by the second scintillator 42, i.e., to absorb photons within the second wavelength (λ2 to λ2′).

In general it is desirable to readout the stacked photodiodes 58 and 60 of the wavelength discriminating photodiode 46 depicted in FIG. 2 such that a measured photocurrent is acquired for each photodiode. In one embodiment, each pixel has two amplifiers to facilitate readout and signal acquisition from the respective photodiodes. For example, referring once again to FIG. 3, a schematic diagram is provided depicting the first and second photodiode 58 and 60 of a pixel of the detector of FIG. 2. In the depicted embodiment, the optical emissions 72 from the first scintillator 38 preferentially excite the first photodiode 58 while optical emissions 74 from the second scintillator 42 preferentially excite the second photodiode 60. A first signal representing the first measured photocurrent 76 may therefore be acquired from the first photodiode 58 via an amplifier. In one embodiment, the amplifier may include an operational amplifier 78 as shown in FIG. 3 configured to function as a current to voltage converter. The operational amplifier may be designed to provide a desired gain, which is then provided to the detector acquisition circuitry 26. A second signal representing the second measured photocurrent 80 may be similarly acquired from the second photodiode 60 via another operational amplifier 82. As will be appreciated by those of ordinary skill in the art, the measured photocurrents 76 and 80 are each linear functions of both the photon fluxes of the first and second scintillators 38 and 42.

In one embodiment, the wavelength discriminating photodiode 46 depicted in FIGS. 2 and 3 is calibrated to the optical wavelengths of interest, and, thereby, to the X-ray energy bands of interest. This may be accomplished using two light sources, such as monochromatic light sources, in which each light source has substantially the same spectral output as one of the wavelength ranges. In this manner, the photodiodes 58 and 60 of the wavelength discriminating photodiode 46 are calibrated to the emission properties of the respective scintillators. In another embodiment, the two signals from the wavelength discriminating photodiode pair are directly calibrated to the two X-ray energy bands of interest. This eliminates the necessity of an intermediate calibration that may be difficult to the extent that the scintillators prevent easy injection of calibrated optical light sources.

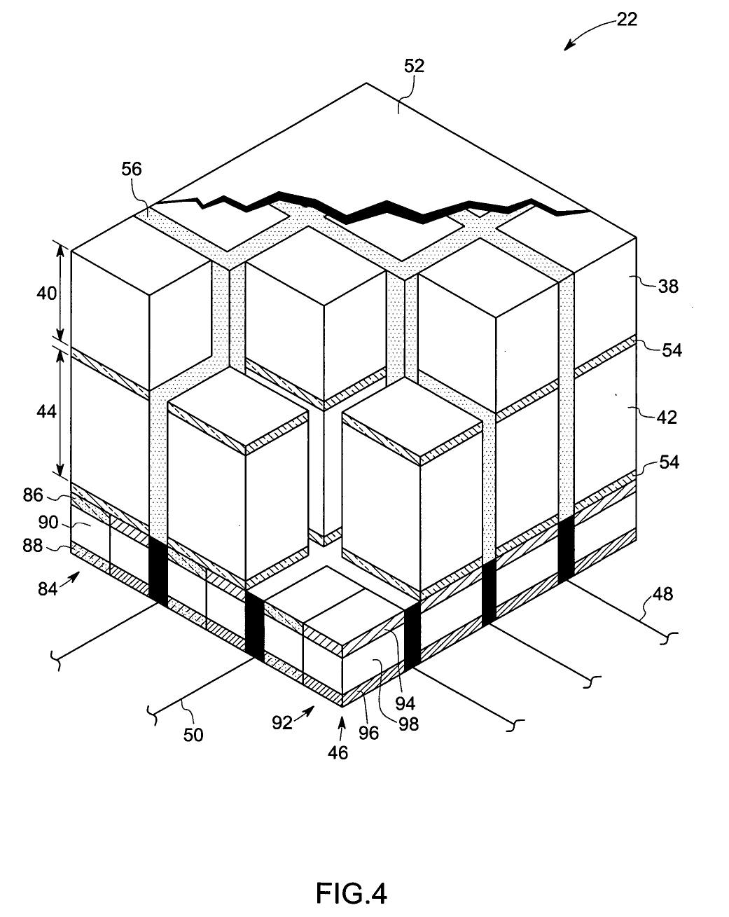

While the stacked photodiode arrangement depicted in FIGS. 2 and 3 is one embodiment of a photo-detecting component of an energy sensitive detector 22, other embodiments are also possible. For example, FIG. 4 is an alternate embodiment of the energy sensitive detector 22 in which the photo-detecting component is a combination of two photodiodes positioned side-by-side. The first photodiode 84 may include a p+ or n+-type layers 86 and 88. In this embodiment, the first photodiode 84 also includes a p- or n-type lightly doped layer 90. Further, layers 86, and 90 are sized and doped such that the first photodiode 84 is relatively more sensitive to photons within the first wavelength range (λ1 to λ1′). The photocurrent current across the lightly doped layer 90 may be read out for each pixel.

Similarly, the second photodiode 92 may include a p+ or n+-type layers 94 and a lightly doped n- or p-type layer 98 sized and doped such that the second photodiode 92 is relatively more sensitive to photons within the second wavelength range (λ2 to λ2′). The photocurrent across the lightly doped layer 98 may be read out for each pixel. In one embodiment each diode has a different quantum efficiency for each wavelength band. As will be appreciated by those of ordinary skill in the art, it is generally desirable that the quantum efficiency of the first photodiode be as close as possible to 1 for the first band and as close as possible to 0 for the second band. Conversely, it is generally desirable that the quantum efficiency of the second photodiode be as close as possible to 0 for the first band and as close as possible to 1 for the second band.

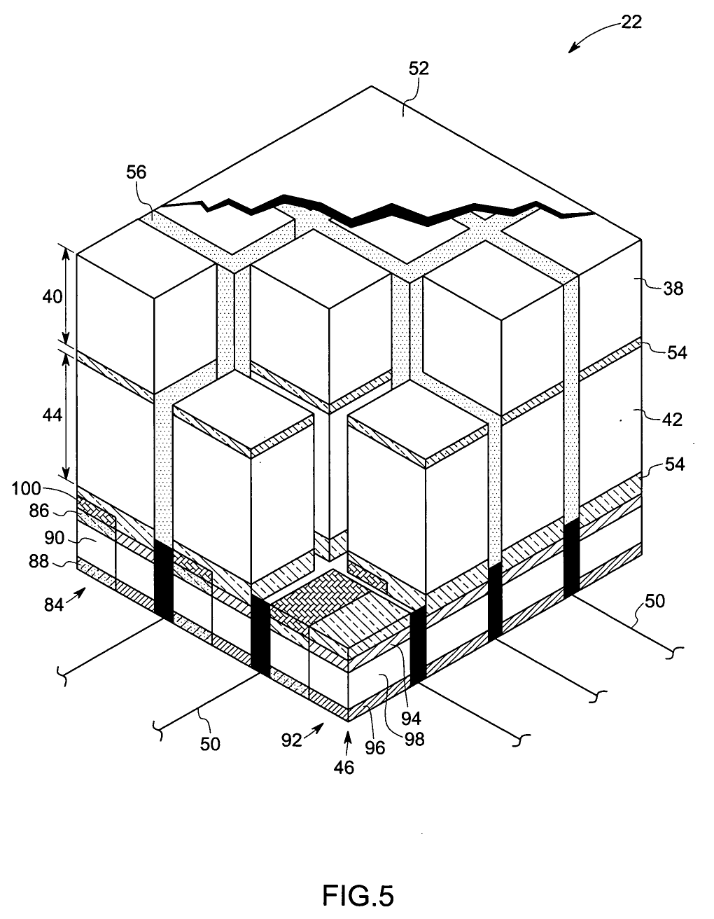

FIG. 5 represents yet another embodiment of the energy sensitive detector 22 in which an optical filter 100 is positioned between the first photodiode 84 and the scintillators 38 and 42, so as to prevent photons within one of the first wavelength range or the second wavelength range from reaching the first photodiode 84. In one embodiment, the photons reaching the second photodiode 92, are unfiltered. Because of the differential filtration provided by the optical filter 100, the entire structure of the two diodes can be the same. Instead, the difference between the signals generated by the respective first and second photodiodes 84 and 92 may provide the desired data regarding the relative amount of light in the two optical wavelength regions and thus the relative amount of high and low energy X-ray incidence on the pixel.

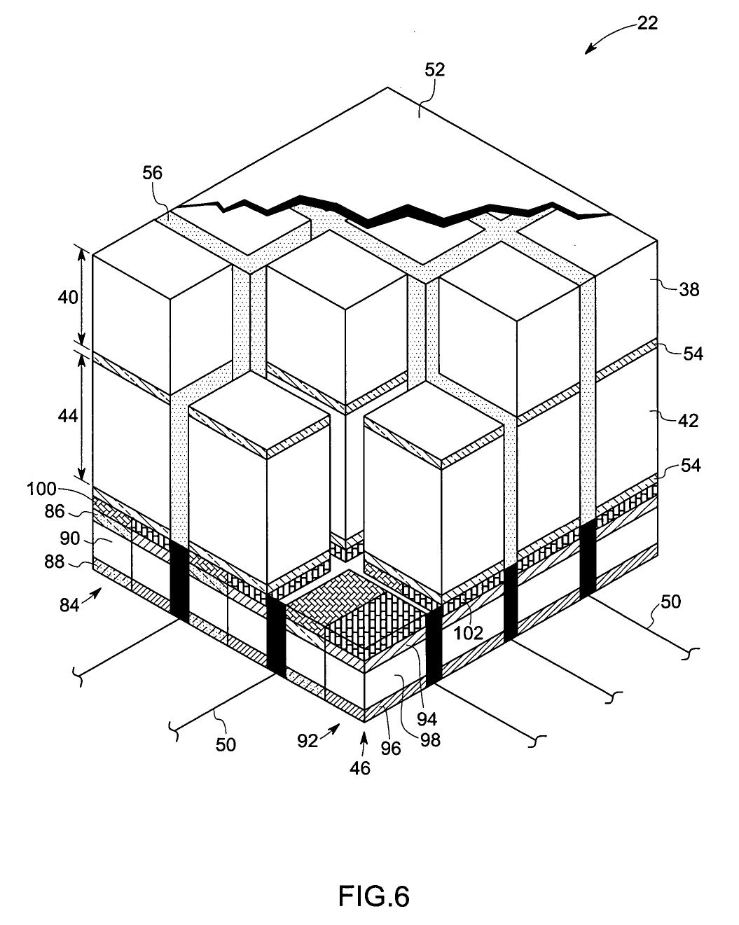

In an alternative embodiment, as depicted in FIG. 6, a second optical filter 102 may be provided over the second photodiode 92 to improve discrimination of the photons emitted by the first and second scintillators 38 and 42. In this embodiment, the second optical filter 102 is configured to permit passage of those photons that are stopped by the optical filter 100, and to block photons that are passed by optical filter 100. In this embodiment, the signals from the first and second photodiodes 84 and 92 may be a simple linear function of the signal from the first and second scintillators 38 and 42. As would be appreciated by those skilled in the art, in the embodiments of FIGS. 5 and 6, the sum of the signals from the first and second photodiodes of each pixel corresponds to the cumulative number of optical photons generated by the first and second scintillator above the pixel, and hence to the total incidence of X-rays on the pixel.

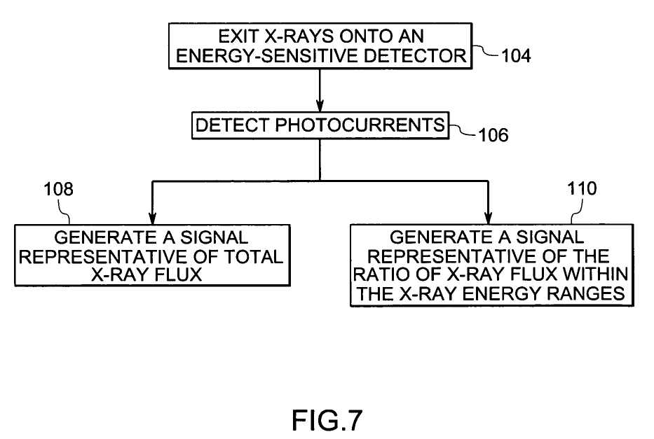

FIG. 7 represents exemplary steps, depicted as a flow chart, for determining the relative amount of X-ray energy at two different X-ray energies using wavelength discriminating photo-detection at each pixel, as described herein. For example, at step 104, X-rays emitted from an X-ray source 12 are incident on an energy sensitive detector 22 incorporating two scintillators and photo-detecting elements such as those described herein. Photocurrents generated by the optical photons emitted by the scintillators are detected at step 106. A first signal is mathematically generated from the detected photocurrents at step 108 that represents to the total X-ray flux. Similarly, a second signal is mathematically generated from the detected photocurrents at step 110 that represents the ratio of the X-ray flux within the two X-ray energy ranges.

By means of example of the aforementioned technique, the measured photocurrents I1 and I2, i.e, the first and second photocurrents, are generated by a wavelength discriminating photo-detector, such as a photo-detecting element described herein. The measured photocurrents I1 and I2, are related linearly to the respective photon fluxes (measured as the number of photons/second/unit area) of the first and second wavelength ranges such that:
I₁=AF₁+BF₂ (1)
I₂=CF₁+DF₂ (2)
where F₁ represents the respective photon fluxes within the first wavelength range (λ₁ to λ₁′), F₂ represents the respective photon fluxes within the second wavelength range (λ₂ to λ₂′), and where A, B, C, and D are constants which depend on the first and second wavelength ranges and the thickness of the layers in the photodiode structure. For an embodiment employing a wavelength discriminating photodiode 46 having stacked photodiodes, as depicted in FIGS. 2 and 3, A, B, C, and D are of similar magnitude. For an embodiment employing a wavelength discriminating photodiode having side-by-side photodiodes with separate optical filtration, as depicted in FIG. 6, B and C may be close to 0.

In general, the values of A, B, C, and D may be determined based on design equations or empirically, such as during calibration. For example, A, B, C, and D may be determined by calibrating the photo-detector using two light sources, such as monochromatic light sources, in which each light source has substantially the same spectral output as the emission properties of one of the respective scintillators. Since the photo-detector behaves linearly, as set forth in equations (1) and (2), the constants A, B, C, and D may be determined from two measurements.

The photocurrents I1 and I2 may be used, in conjunction with knowledge about the first and second scintillators, to determine the respective X-ray fluxes, FX1 and FX2, on the pixel at the two energy levels, E1 and E2. In particular, for a given scintillator:
F₁=A_{X}F_{X1}+B_{X}F_{X2} (3)
F₂=C_{X}F_{X1}+D_{X}F_{X2} (4)
where the coefficients A_{X}, B_{X}, C_{X}, and D_{X} may be calculated using standard X-ray absorption modeling techniques based on the X-ray absorption strength of each scintillator at each X-ray energy and the thickness of each scintillator.

In view of equations (1)-(4), the measured photocurrents may be represented as:
I₁=aF_{X1}+bF_{X2} (5)
I₂=c_{F}_{X1}+dF_{X2} (6)
where a=(AA_{X}+BC_{X}), b=(AB_{X}+BD_{X}), c=(CA_{X}+DC_{X}), and d=(CB_{X}+DD_{X}).

The above equations may be inverted to give:
F_{X1}=a′I₁+b′I₂ (7)
F_{X2}=c′I₁+d′I₂ (8)
where the new constants may be determined using linear algebra. Using equations (7) and (8), the relative amounts of two different X-ray energies incident on a pixel may be determined in circumstances where the photo-detector and scintillator respond linearly to the respective photon and X-ray energy sources.

It is worth noting that, in some circumstances, the non-linear responses may arise which cause deviations from equations (7) and (8). For example, X-ray absorption in the scintillator layers depends on the X-ray energy. The shape of the X-ray spectrum within each energy band changes as the X-ray beam is attenuated and scattered as it passes through the object. As a result, a change in the spectral shape associated with the X-ray energy may produce non-linearities in scintillator response to the extent this change is not reflected in the optical photon spectrum produced by the scintillator. These potential non-linearities may be addressed by adding second order non-linear terms to equations (7) and (8) (or, equivalently, to equations (5) and (6)). For example, based on empirical measurement or simulation of how X-ray spectral shape varies as a finction of the characteristics (thickness, composition, and so forth) of the imaged object, higher order coupling terms may be introduced to equations (7) and (8), such that:
F_{X1}=a′I₁+b′I₂+eI₁I₂ (9)
F_{X2}=c′I₁+d′I₂+fI₁I₂ (10).

The non-linear coupling constants e and f may be determined experimentally, such as by varying the intensity of the X-ray fluxes to replicate shift in X-ray spectral shape which may arise when imaging an object. For example, the intensity of X-ray fluxes may be varied by attenuating the X-ray beam with different thickness of an attenuating material.

While only certain features of the invention have been illustrated and described herein, many modifications and changes will occur to those skilled in the. art. It is, therefore, to be understood that the appended claims are intended to cover all such modifications and changes as fall within the true spirit of the invention.

1. An energy sensitive detector comprising:
an array of detector elements, wherein each detector element comprises:
a first scintillator configured to emit photons within a first wavelength range when stimulated by X-rays;
a second scintillator configured to emit photons within a second wavelength range when stimulated by X-rays; and
a photo-detecting component configured to generate a first signal and a second signal, wherein the first signal and second signals are substantially linear functions of the number of photons emitted within the first and second wavelength ranges.

2. The energy sensitive detector of claim 1, wherein the first scintillator is above the second scintillator.

3. The energy sensitive detector of claim 1, wherein the second wavelength range is at least 10 nanometers away from the first wavelength range.

4. The energy sensitive detector of claim 1, wherein the first scintillator is configured to absorb low energy X-rays.

5. The energy sensitive detector of claim 4, wherein the first scintillator is configured by constructing the first scintillator from one or more materials adapted to absorb low energy X-rays.

6. The energy sensitive detector of claim 4, wherein the first scintillator is configured by constructing the first scintillator at a thickness adapted to absorb low energy X-rays.

7. The energy sensitive detector of claim 1, wherein the second scintillator is configured to absorb high energy X-rays.

8. The energy sensitive detector of claim 7, wherein the second scintillator is configured by constructing the second scintillator from one or more materials adapted to absorb high energy X-rays.

9. The energy sensitive detector of claim 7, wherein the second scintillator is configured by constructing the second scintillator at a thickness adapted to absorb high energy X-rays.

10. The energy sensitive detector of claim 1, wherein the photo-detecting component comprises a wavelength discriminating photodiode.

11. The energy sensitive detector of claim 1, wherein the photo-detecting component comprises a first photodiode and a second photodiode arranged side-by-side and wherein the first photodiode generates the first signal and the second photodiode generates the second signal.

12. The energy sensitive detector of claim 11, wherein the first photo diode is substantially sensitive only to photons within the first wavelength range.

13. The energy sensitive detector of claim 11, wherein the first photodiode is substantially sensitive only to photons within the first wavelength range and the second photodiode is substantially sensitive only to photons within the second wavelength range.

14. The energy sensitive detector of claim 11, comprising an optical filter between the first photodiode and the scintillators.

15. The energy sensitive detector of claim 14, comprising a second optical filter between the second photodiode and the scintillators, wherein the second optical filter has different transmission characteristics than the first optical filter.

16. The energy sensitive detector of claim 1, comprising readout circuitry configured to acquire the first signal and the second signal.

17. The energy sensitive detector according to claim 1, wherein the at least one of the first scintillator or the second scintillator comprise at least one of (Y,Gd)₂O₃:Eu, Gd₃Ga₅O₁₂:Cr, (Lu,Tb)₃Al₅O₁₂:Ce, CdWO₄, or Gd₂O₂S:Pr.

18. An X-ray imaging system, the system comprising:
an X-ray source configured to emit X-rays;
an energy sensitive detector comprising:
an array of detector elements, wherein each detector elements comprises:
a first scintillator configured to emit photons within a first wavelength range when stimulated by X-rays;
a second scintillator configured to emit photons within a second wavelength range when stimulated by X-rays;
a photo-detecting component configured to generate a first signal and a second signal, wherein the first signal and second signals are substantially linear functions of the number of photons emitted within the first and second wavelength ranges.
detector acquisition circuitry configured to acquire the first signal and the second signal from the energy sensitive detector;
a system control circuitry configured to control at least one of the X-ray source and the detector acquisition circuitry; and
an image processing circuitry configured to process the first signals and the second signals to generate an image.

19. The X-ray imaging system of claim 18, comprising an operator workstation configured to display the image on at least one of a display and a printer.

20. The X-ray imaging system as recited in claim 18, wherein the system control circuitry is configured to control a power supply to the X-ray source.

21. The X-ray imaging system as recited in claim 18, wherein the photo-detecting component comprises a wavelength discriminating photodiode.

22. The X-ray imaging system as recited in claim 18, wherein the photo-detecting component comprises a first photodiode and a second photodiode arranged side-by-side and wherein the first photodiode generates the first signal and the second photodiode generates the second signal.

23. The X-ray imaging system as recited in claim 22, wherein the photo-detecting component comprises an optical filter disposed between the first photodiode and the scintillators.

24. The X-ray imaging system as recited in claim 23, wherein the photo-detecting component comprises a second optical filter between the second photodiode and the scintillators, wherein the second optical filter has different transmission characteristics than the first optical filter.

25. The X-ray imaging system as recited in claim 18, wherein the energy sensitive detector comprises readout circuitry configured to acquire the first signal and the second signal for the detector acquisition circuitry.

26. The X-ray imaging system as recited in claim 18, comprising a motor subsystem for moving at least one of the X-ray source and the energy sensitive detector.

27. A method of forming an energy sensitive detector, the method comprising the steps of:
forming a first scintillator layer configured to emit photons within a first wavelength range when stimulated by X-rays;
forming a second scintillator layer configured to emit photons within a second wavelength range when stimulated by X-rays; and
forming an array of photo detecting elements configured to generate a first signal and a second signal, wherein the first signal and second signals are substantially linear functions of the number of photons emitted within the first and second wavelength ranges.

28. A method for acquiring X-ray energy data comprising the steps of:
emitting X-rays onto a energy sensitive detector comprising a first scintillator and a second scintillator such that the first scintillator emits photons within a first wavelength range and the second scintillator emits photons within the second wavelength range;
detecting the incidence of emitted photons on one or more photo-sensitive elements, wherein each element is configured to produce a first signal proportional to photons emitted within the first wavelength range and a second signal proportional to photons emitted within the second wavelength range; and
determining a relative amount of X-rays at two or more energy bands incident on each element based on the first signal and the second signal.

29. The method of claim 28, wherein determining the relative amount comprises determining a total X-ray flux on each element and a measure of the average energy of the X-ray flux using the first signal and the second signal.

30. The method of claim 28, determining the relative amount comprises solving a set of equations using the first signal and the second signal.

31. The method of claim 28, wherein the one or more photo-sensitive components each comprise a wavelength discriminating photodiode.

32. The method of claim 28, wherein the one or more photo-sensitive components each comprise a first photodiode and a second photodiode arranged side-by-side and wherein the first photodiode generates the first signal and the second photodiode generates the second signal.
